(19) United States
(12) Patent Application Publication
(10) Pub. No.: US 2017/0272449 A1
(43) Pub. Date: Sep. 21, 2017

(54) PROVIDING PERMISSIONS TO SPAWNED COMPUTING RESOURCES

(71) Applicant: Conjur, Inc., Waltham, MA (US)

(72) Inventor: Kevin Gilpin, Weston, MA (US)

(21) Appl. No.: 15/464,538

(22) Filed: Mar. 21, 2017

Related U.S. Application Data
(60) Provisional application No. 62/311,109, filed on Mar. 21, 2016.

(51) Int. Cl. H04L 29/06

(52) U.S. Cl. CPC H04L 63/105; H04L 63/083

(57) ABSTRACT

Implementations providing permissions to spawned computing resources within a computing environment include initiating a first computing resource whose operation is limited by a first set of permissions, for example, user-credential-based permissions. Permissions can be based on credentials of a user interfacing within the computing environment. A second computing resource spawned from the first computing resource is then identified and a second set of permissions is provided to the second computing resource. The second set of permissions is at least as restrictive in scope as the first permission set.

### RELATED APPLICATIONS

This application hereby claims the benefit of and priority to the following, which is incorporated by reference in its entirety (including any appendices thereto): U.S. Provisional Patent Application 62/311,109, entitled “PROVIDING PERMISSIONS TO SPAWNED COMPUTING RESOURCES,” filed 21 Mar. 2016 (Attorney Docket No. 7160004P).

### TECHNICAL FIELD

Aspects of the disclosure are related to the field of access control in computing environments.

### TECHNICAL BACKGROUND

Virtualization techniques have gained popularity and are now commonplace in data centers and other computing environments in which it is useful to increase computing resource efficiency and utilization. In a virtualized environment, one or more virtual nodes are instantiated on an underlying host computer and share the resources of the underlying computer. Rather than implementing a single node per host computing system, multiple nodes may be deployed on a host to more efficiently use the processing and other computing resources of the computing system. These virtual nodes may include full operating system virtual machines, Linux containers, such as Docker containers, jails, or other similar types of virtual containment nodes.

Computing environments can “spin up” and “spin down” processing nodes and services as they are required. For example, when a user requires a virtual machine, computing resources can be allocated to the end user and a virtual machine initiated on a host computing system. This new virtual machine may then receive permissions (e.g., end-user-based permissions that define a given user's permitted access to and interaction with a given computing resource) that define and, in many cases, limit the ability of the end user of the virtual machine to access, write, read, and manipulate data within the computing environment. Once a new virtual node is initiated, the virtual node may, in some examples, instantiate, generate, or otherwise spawn new virtual nodes or other computing resources to provide desired operation. However, as the computing environment becomes more complex, managing the permissions of the spawned resources can become difficult and burdensome.

### OVERVIEW

Examples described herein provide permissions to spawned computing resources in a computing environment. In some implementations, methods of providing permissions to spawned computing resources include initiating a first computing resource that possesses a first set of permissions (e.g., a user-credential-based permissions set comprising permissions that limit a computing resource's operation, defining a given user's permitted access to and interaction with a given computing resource, some user-based permissions being based on a user's role designation and/or identity, as established through user credentials). The methods further include identifying a second computing resource spawned from the first computing resource, and providing a second set of permissions to the second computing resource, wherein the second set of permissions are the same as or more restrictive than (i.e., do not exceed or grant broader permissions than) the first set of user permissions.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a computing environment to provide permissions to spawned computing resources.

FIG. 2 illustrates a method of providing permissions to spawned computing resources in a computing environment.

FIG. 3 illustrates an operational scenario of providing parent test machine permissions to spawned virtual nodes.

FIG. 4 illustrates a computing system to provide permissions to spawned computing resources according to one or more implementations.

### DETAILED DESCRIPTION

The various figures and descriptions included herein discuss many examples for enhanced permission management in a computing environment. In many computing networks, computing resources may be “spun up,” instantiated, or otherwise initiated based on the current requirements of a particular party (e.g., an end user or organization, possibly an organization responsible for the computing environment). These computing resources may include one or more virtual nodes, such as whole operating system virtual machines or containers, one or more real or host computing systems, storage systems, applications, or any other similar computing resource(s).

Within organizations and other groups of users, the users can be assigned permissions that define how those users (and/or the computing resources they invoke or use) are permitted to act on and/or interact with computing resources inside and outside a given computing environment. Stated another way, permissions define what actions a user can perform on and/or in connection with specified objects and other computing resources. These permissions can be expressed by identifying a type of computing resource and the way a given user is allowed to act on and/or interact with that computing resource. In some implementations permissions are implemented in a computing environment by assigning selected permissions to roles within an access control system in which each user is assigned to one or more roles that enable the user to exercise the permissions associated with each assigned role. In some implementations a group of permissions applicable to a given user (i.e., a user-based permission set) is invoked when that user initiates use of a computing system. Implementations of providing permissions to spawned computing resources have the technical effect of enabling and/or enhancing enforcement of permission limitations (e.g., through operational restrictions and definitions) that apply with regard to spawning computing resources and a given user.

Authorization controls access to resources in a given setting and permissions (e.g., rules and the like) governing such access can be created and applied by administrators and/or others. Every user and host can possess specific permissions based on his/her/its role(s) and the permissions granted to such role(s). Admins and/or the like can set up permissions models (e.g., creating user and host identities, organizing users into groups, organizing hosts into layers, granting permissions between users, hosts and resources).

A spawned computing resources control system can be part of a broader authentication and authorization system or the like. For example, in some implementations, various systems and functionalities can perform a variety of functions based on role-based access control, non-limiting examples of which include (1) creation and maintenance of authorization permissions, and (2) enforcing permission-based access to resources by users, spawned resources, and the like (also referred to as transaction control that is role-based—for example, where an RBAC “transaction” includes three parts: a role, a permission (e.g., a privilege), and a resource). Non-limiting examples of this type may be used to help illustrate implementations of controlling access to spawned computing resources in a computing environment herein. A “role” identifies the subject: who or what is acting. This can be a specific identity such as a user or machine (including a virtual machine), or a generic group identity. A role possesses privileges and is authorized to initiate transactions. Again, a role may represent a person, a group, a non-human user (“robot”) such as a virtual machine or process, or a group of other roles. Resources are entities (e.g., a protected asset, such as a database, service and/or an encrypted secret) on which permissions are defined.

In addition to having privileges, a role can be granted to another role and permissions can be granted as well. When a role is granted, the receiving role can gain all the privileges of the granted role. The receiving role (e.g., an individual) gains all the roles that are held by the new role; thus, role grants can be fully inherited. If a user or other role attempts a transaction, that transaction will be allowed if the user or any inherited role(s) has the required privilege. Likewise, permissions affecting access to one or more resources can be controlled with regard to passing on those permissions when resources are spawned in a computing environment.

A permissions module (and/or a similar device or functionality) can control resource access and permissions regulation of various types. For example, “reading” a resource may be a permission to show record attributes. “Executing” can be permission to invoke the record (e.g., fetching the value of a secret, invoking a web service endpoint function). “Updating” can be permission to modify a record (e.g., modifying the value of a secret).

As computing resources are initiated within a computing environment, permissions are provided to the initiated resources (e.g., to limit a given user's actions in connection with the initiated computing resource). These permissions may include read, write, edit, run, revoke, create and delete actions with regard to disks, databases, applications, code and other computing resources, or any other similar permissions that might be associated with an initiating computing resource.

In addition to original computing resources initiated by an authorized user of the computing environment, the original computing resource may spawn (e.g., create, initialize, request or otherwise generate) a second computing resource that is required to execute necessary operations. In one or more implementations the newly spawned computing resources spawned resources are provided with permissions as described herein. The permissions provided to any of the spawned resources (e.g., child or grandchild resources) are limited by the scope of permissions provided to the spawning computing resources. In particular, the permissions provided to a spawned resource are configured to not exceed the breadth or scope of permissions available in connection with the spawning resources. In a non-limiting example, if a virtual machine parent resource has limited write permissions to a particular storage volume, then any virtual machine and/or other computing resource spawned from the virtual machine parent resource can only be provided with either the same or more limited write permissions to the same storage volume.

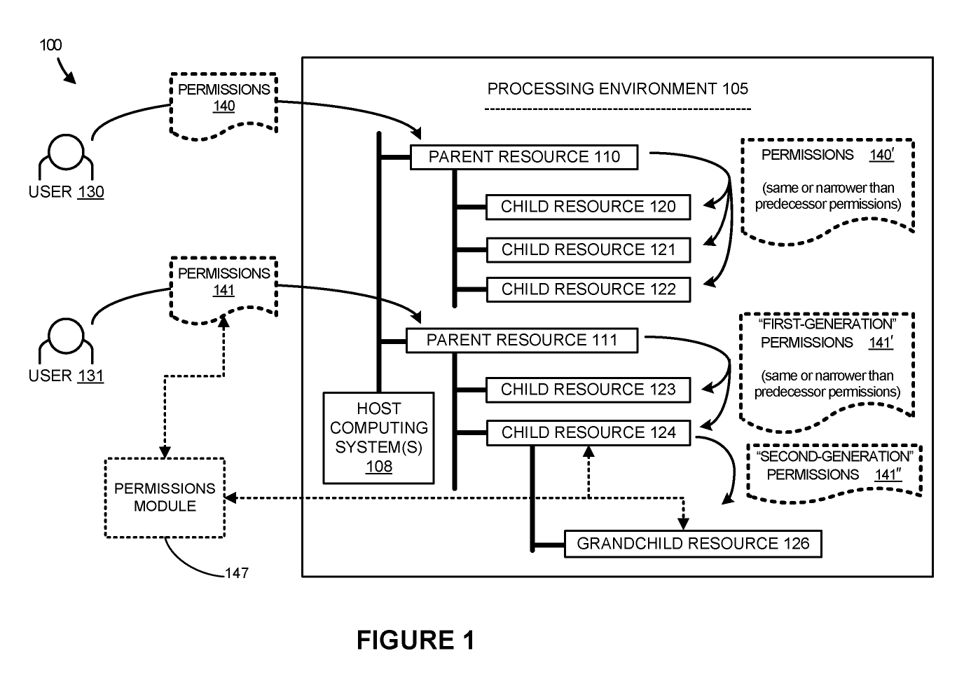

FIG. 1 further illustrates one or more implementations of providing permissions to spawned computing resources in an access control system. FIG. 1 illustrates a computing environment 100 in which permissions are provided to spawned computing resources by the computing resources that spawn them. Computing environment 100 includes processing environment 105 and users 130, 131. Computing environment 100 comprises one or more host computing systems, routers, switches, and/or other similar computing systems 108 capable of providing parent resources 110, 111 that spawn child resources 120-124, which may comprise physical computing systems, whole operating virtual machines, containers, or some other similar resource. Also, in the non-limiting example of FIG. 1, one of the child resources 124 spawns grandchild resource 126. Child and grandchild resources 120-124, 126 may be transitory (e.g., a temporary instantiation of an application or virtual machine), so that permissions concerning such resources may reflect ensuring that a given resource is not viable beyond its required shut-down point and, once it is shut down, that it is not resurrected in an unauthorized manner.

In operation, user 130 initiates parent resource 110 (e.g., one or more host computing systems, full operating system virtual machines, containers, or some other similar resource within the environment) within processing environment 105. For example, user 130 may initiate a virtual machine to execute a particular application within the computing environment. User 130 may have permissions set 140 associated with that user's identity, credentials, role or other identification in processing environment 105; these permissions 140 then apply to user 130's interactions with parent resource 110. In some implementations, user 130 may interact directly with a computing system in processing environment 105 via a user interface on the computing system. However, in other examples, it should be understood that user 130 may communicate with a computing system in processing environment 105 using a console device and Internet protocol (IP) or some other communication protocol, thus addressing, communicating with and interacting with the new computing resource user 130 from a remote computing console, such as a desktop, mobile device, tablet, smart phone, laptop, or other computing device.

During operation of parent resource 110, child resources 120-122 may be spawned by parent resource 110 to provide desired or required operations within processing environment 105. For example, if a (first) parent resource 110 requires generation of a virtual machine (a second computing resource) responsible for managing a database, such a virtual machine can be spawned to provide the desired operation. Permissions 140′ are provided to each newly-spawned resource and are based on and are no broader than the permissions 140 initially obtained by the parent computing resource 110. In some implementations the parent resource's permissions can be updated from time to time, which can permit updating of the permissions of the spawned resource(s) as well (e.g., at the time it is spawned and/or thereafter). In the present example, parent resource 110 may obtain (or otherwise be subject to) a set of permissions 140 based on the credentials of user 130 (e.g., based on a user's designated role in a role-based access control system, based on a user's credentials (e.g., a user identification and password combination), as well as other user-credential-based permissions sets comprising permissions that limit a computing resource's operation, defining a given user's permitted access to and interaction with a given computing resource, wherein some user-based permissions are based on a user's role designation and/or identity, as established through user credentials). Accordingly, when parent resource 110 spawns new child resources 120-122, the child resources receive, inherit and/or are subject to the same (or more restrictive) sets of permissions, designated as permission set(s) 140′ in FIG. 1. Restricting permissions utilized by a spawned resource (e.g., a child resource) to the same or narrower permissions possessed by the spawning resource (here, a parent resource) prevents spawned resources from improperly accessing, creating, modifying, deleting and/or otherwise interacting with other resources on the same network and/or other resources external to the network. For instance, if a parent resource 110 is only allowed to communicate with particular IP addresses, then each spawned offspring resource 120-122 is similarly allowed to communicate only with the same or fewer defined IP addresses.

Similar limiting of permissions can be implemented by parent resource 111 in connection with user 131. In particular, when user 131 initiates parent resource 111, it possesses permissions 141 that are associated with user 131 (e.g., user 131's permissions may be limited and/or defined by that user's role designation(s) and/or other access control scheme(s) implemented in a given organization or computing system). Permissions 141 applicable in the communications, actions and interactions between user 131 and parent resource 111 may then be provided in whole or in part as permissions 141′ to child resources 123-124 as they are initiated from parent resource 111. These first-generation permissions 140′, 141′ may comprise permissions equivalent to permissions 140 and 141, respectively, but may also comprise any other set(s) of permissions based on users 130 and 131, respectively. In some implementations the first generation permissions must be no broader than the parent permissions. In other embodiments the identity of a user (e.g., user 130 or user 131) might make allocation of other permissions possible. Likewise, second-generation permissions 141″ may comprise permissions equivalent to or narrower than permissions 141′. By “delivering” permissions to resources in various implementations, the spawning resource can either directly provide (e.g., transmit, install) a data block, table or other definition of permissions to the spawned resource or the spawned resource can be provided with access to a permissions module 147 or the like that controls permissions for computing environment 100. As seen in FIG. 1, such a permissions module 147 can coordinate and regulate permissions concerning user 131 with regard to permissions 141, first-generation permissions 141′ and second-generation permissions 141″ in some implementations.

In a non-limiting example, an organization may assign various classifications to end users or employees of the organization (e.g., in a RBAC system) Based on a given end user's classification, the end user can be provided with permissions (e.g., access to specific files, access to specific directories, access to specific servers, access to specific IP addresses, read-only access to resources, resource creation, resource updating, external communication, internal communication, resource deletion) regarding resources (e.g., processing resources, storage systems, network addresses). Moreover, the permissions inherited by a spawned resource from a spawning entity may be dependent upon the nature of the spawned resource (e.g., a spawning entity may deliver different permissions to a spawned database management resource than would be delivered to a spawned communication resource).

Although only three generations of resource levels are illustrated in FIG. 1, it should be understood that any number of levels, generations, etc. of resources may spring from a parent resource. For example, in some implementations, if a user initiates an application within a first virtual machine, the application may generate a second virtual machine (a “child resource”), which in turn then generates a third virtual machine (a “grandchild resource”). In such a situation the parent resource is a spawning resource, the child resource is both a spawned resource and a spawning resource, and the grandchild resource is a spawned resource.

These generationally descended virtual machines can all be provided with the same permissions provided to the original application. However, in some implementations one or both of the child and grandchild virtual machines may have permissions that are narrower than the creating resource. If the first virtual machine in this example provides narrower permissions to the second (spawned child resource) virtual machine, then that second virtual machine is unable to provide permissions to the third virtual machine of the same scope as those possessed by the first virtual machine. If the permissions possessed by the first, second and third virtual machines are denoted P(VM1), P(VM2) and P(VM3), respectively, then the following are true: P(VMT) P(VM2) and P(VM2) P(VM3).

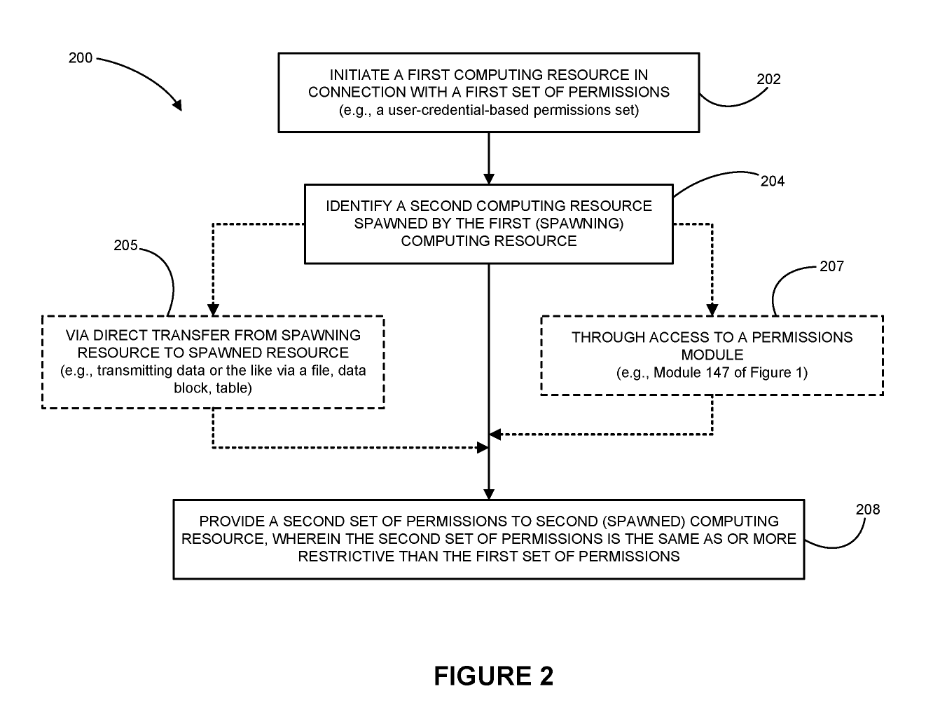

Referring to FIG. 2, a method 200 of delivering or otherwise providing all or some spawning parent resource permissions to spawned offspring computing resources in a computing environment is shown. Method 200 is described with reference to elements, systems, etc. from computing environment 100 from FIG. 1. The operations of FIG. 2 are described parenthetically in the description below.

As described in FIG. 1, a processing environment may include host computing systems with other switches, network access nodes, and routers to provide processing resources for end users who interact with the processing environment. Processing resources can include one or more physical computing systems, one or more full operating system virtual machines, one or more containers, or some other physical or virtual resource. These resources provide a platform for one or more user applications, systems, networks, or other operations.

To implement provision of permissions to spawned resources, method 200 includes initiating a first computing resource in connection with a first set of user permissions (202), for example a user-credential-based permissions set. Using the example of user 130 and parent resource 110, a user may request (directly or indirectly), or otherwise implement or invoke, a new computing resource; the user can access processing environment 105 either “locally” within processing environment 105, or “externally” via a communication link between processing environment 105 and a remote desktop, secure shell, or some other similar interface device. As part of initiating the first computing resource, user 130 may provide credentials and/or secret information (e.g., a username and password) associated with user 130, and responsively be provided with access to the desired computing resource.

In some implementations, processing environment 105 includes a permission allocation module 147 (e.g., located on one or more physical computing elements external to or within processing environment 105, for example implemented as a security service controlling secrets and security for the processing environment 105). For example, in some implementations, if the user requires a virtual machine, the permission provision module identifies the virtual machine request, identifies and verifies authorizing information (i.e., credentials, passwords, secrets) associated with the user, and then generates, conveys, grants access to or otherwise provides applicable permissions associated with the credentials to the new virtual machine (i.e., the first computing resource). In providing permissions to the new virtual machine, one or more software modules may be configured to apply the desired network configurations, apply data read/write permission configurations, and/or perform any other similar configuration operations in connection with the required resource for the end user.

Once the parent (first computing) resource is configured with (or has access to) the appropriate permissions, method 200 further includes identifying a second computing resource spawned by the first (spawning) computing resource (204). As described herein, although a first computing resource may be specifically initiated by a user, that first resource might need to spawn new computing resources to support the first computing resource's operations. For example, if the user initiates a first virtual machine with an application capable of spawning new virtual machines for other requesting end users, new virtual machines may be required to be “spun up” or initiated in response to a request from an end user. Referring to the example of FIG. 1, user 130 may generate parent resource 110 which comprises an application capable of generating additional virtual nodes. In response to a requirement, a child (spawned) computing resource (e.g., one of child resources 120-122) may be initiated within processing environment 105. In some implementations, the spawned computing resource may be initiated on the same physical computing system as parent resource 110, however, in other implementations, the spawned resource may be initiated on one or more separate computing systems.

After a spawned resource is identified in connection with the spawning parent resource, method 200 provides for allocating a second set of permissions to the second computing resource, wherein the second set of permissions do not exceed the first set of user permissions (206). As described previously, when a user generates a parent resource, permissions are provided to the spawned parent resource. These permissions may be defined by the user, credentials associated with the user, or by any other appropriate means. The second set of permissions delivered by the spawning resource to (or inherited by) the spawned resource do not exceed the scope of the original parent resource's permissions. In some implementations these permissions can be pass via direct transfer (e.g., of a file, data block, table) from the spawning resource to the spawned resource (205). In some implementations the permissions may be defined and/or enforced by a permissions module 147 or the like to which the spawned resource is provided access and that controls permissions for a processing environment and/or computing environment (207).

As noted, to implement the desired permissions within the child resource, a permissions module 147 located within the computing environment (though external to processing environment 105 in some implementations) may be used to provide the desired configuration. This permissions module 147, which may be located on one or more of the computing systems within the environment, may identify spawning of the child resource (and/or respond to an access request from the spawned resource) and can deliver or otherwise provide access to the required permission attributes to the spawned resource. Permissions module 147 may also be an external security service that enforces permissions and other security measures within processing environment 105. Once the spawned resource inherits the required permissions set, it can implement desired operations that are limited by that permissions set. Accordingly, if permissions set 140 only permitted parent resource 110 to communicate with a set of IP address, then permissions 140′ granted to spawned child resource 120 would similarly only be permitted to communicate with the set of :IP addresses (or with a more restricted subset of those IP addresses

Although some implementations provide identical permissions to spawned resources, it should be understood that the permissions provided to spawned resources may comprise any set of permissions that doesn't exceed scope of permissions provided to the spawning parent resource. For example, if parent resource 110 has permission to read from a particular data storage drive on a host computing system, then spawned computing resources 120-122 can be restricted via provided permissions to either no access to the same storage drive, or to read-only access the data storage drive that is equivalent to the permission held by spawning parent resource 110. However, spawned child resources 120-122 cannot be provided with read and write access to the data storage drive via permissions that would exceed the scope of the spawning computing resource's permissions.

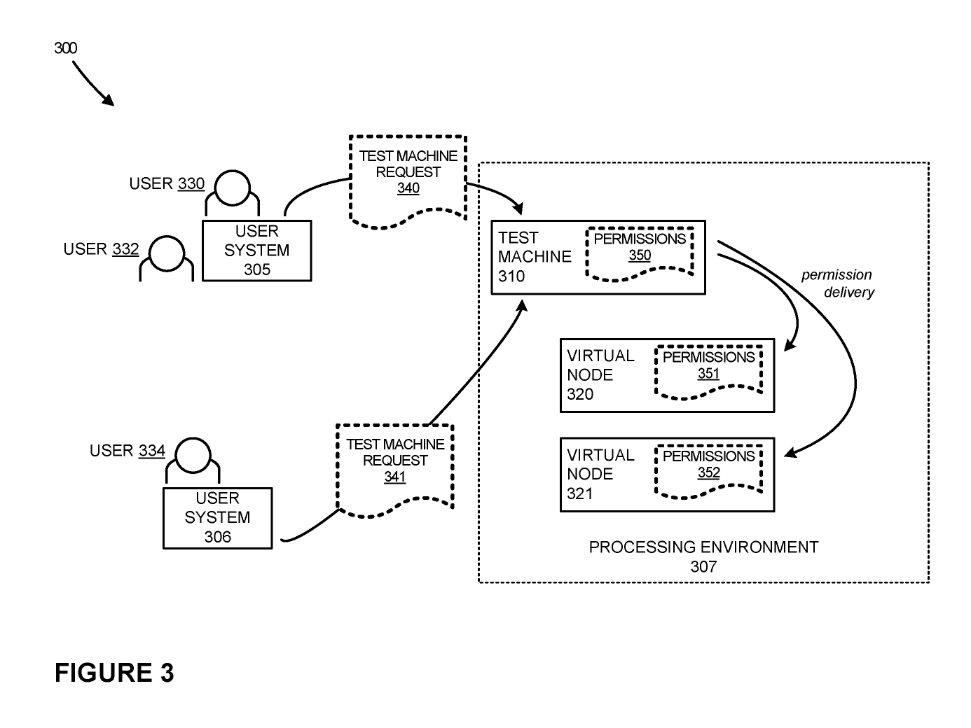

To further demonstrate providing permissions (e.g., user-credential-based permission sets) to child resources, FIG. 3 is provided. FIG. 3 illustrates an operational scenario 300 of providing parent test machine permissions to children virtual nodes. Operational scenario 300 includes user system 305, user 330, and process environment 307. Processing environment 307 may include one or more physical computing systems, switches, routers, or other similar computing systems capable of providing test machine 310 and virtual nodes 320, 321.

In operation, user 330 uses user system 305 to generate a test machine request 340 to initiate test machine 310. Test machine 310 may comprise one or more of a serving computing system, a desktop computing system, a full operating system virtual machine, or any other similar test computing system within processing environment 307. Although illustrated as configuring test machine 310 externally via user system 305, it should be understood that in some implementations, user 330 may directly configure test machine 310 employing a user interface of test machine 310. During configuration of test machine 310, permissions 350 are supplied to test machine 310 (again, this may be done directly via the test machine request 340 or through interaction with a permissions server, module, etc. (not shown) that is located inside or outside processing environment 307). Thus a permissions set 350 (e.g., a user-credential-based permissions set) may be supplied via a specification by user 330, may be supplied based on credentials associated with user 330 a username and password), or may be supplied in any other manner.

The permissions 350 may include network access permissions, storage system access permissions, read/write permissions, application install permissions, and/or other permissions.

Once test machine 310 has been initiated by user 330, child resources are spawned from test machine 310. In the non-limiting example of FIG. 3, the spawned child resources include virtual node 320 and virtual node 321, which may comprise full operating system virtual machines, containers, or some other similar virtualization node, including combinations thereof. When a required virtual node is spawned by test machine 310 using an application or some other process on test machine 310, permissions are provided to each virtual node based on the original permissions 350 provided to test machine 310.

In particular, permissions provided to a new virtual node cannot be broader in scope than the original permissions 350 that were provided to test machine 310. For example, if permissions 350 included network permissions to communicate with all other physical and virtual computing systems in processing environment 307, then virtual nodes 320, 321 may each be configured with permissions 351, 352, respectively, that allow those virtual nodes to communicate with all other physical and virtual computing systems in processing environment 307. Alternatively, in some implementations, one or both of virtual nodes 320, 321 may be configured to communicate with smaller subsets of the physical and virtual computing systems in processing environment 307, including, in some examples, none of the other systems within processing environment 307. However, virtual nodes 320, 321 spawned from test machine 310 cannot include permission to communicate with any computing system (real or virtual) outside of processing environment 307. Moreover, permissions 351 do not have to be identical to permissions 352 and, in fact, permissions 351 and permissions 352 may not “overlap” at all.

In at least one implementation, a different end user 332 might use the same user system 305 to transmit a test machine request 340. The permissions 350 provided to test machine 310 can be based on the user, here end user 332 rather than end user 330, thus resulting in potentially different permissions being provided to test machine 310 and thus possibly affecting the scope of permissions potentially provided to spawned computing resources 320, 321. If original permissions 350 are based, however, on the user system 305, then they would be the same as those provided to test machine 310 for the test machine request of end user 330.

Another end user 334 may use or initiate test machine 310 and its spawned virtual nodes 320, 321. Again, the permissions 350 provided to test machine 310 might be different if they are user-based permissions and might be different if they are based on the user system 306 from which the test machine request 341 is sent. Consequently, although a new user of a virtual nodes 320, 321 may desire different permissions in the spawned-resource permissions 351, 352, the permissions are dependent upon the original permissions provided to test machine 310.

In some implementations, users that request virtual nodes 320, 321 may specify the first-generation provided permissions 351, 352 from the available permissions 350. However, in other implementations, inherited permissions can be provided automatically to spawned virtual nodes via test machine 310. This automatic allocation may be based on a process executing on the test machine 310, an event that spawned a new virtual node, or any other similar permission definition, allocation and/or other mechanism.

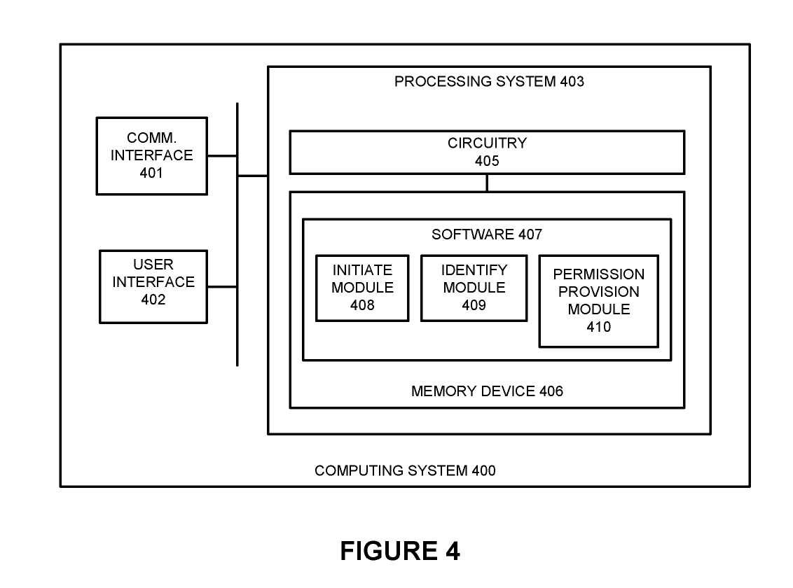

FIG. 4 illustrates a computing system 400 to provide or otherwise participate in providing permissions to spawned computing resources according to one or more implementations. Computing system 400 is representative of any computing system or systems with which the various operational architectures, processes, scenarios, and sequences disclosed herein for a processing environment may be implemented. Computing system 400 may be an example of processing environment 105, host computing system 108, processing environment 307, and/or permissions module 147, although other examples may exist. Computing system 400 may comprise one or more server computing systems, desktop computing systems, routers, gateways, switches, and other similar computing elements. Computing system 400 comprises communication interface 401, user interface 402, and processing system 403. Processing system 403 is linked to communication interface 401 and user interface 402. Processing system 403 includes processing circuitry 405 and memory device 406 that stores operating software 407.

Communication interface 401 comprises components that communicate over communication links, such as network cards, ports, radio frequency (RF) transceivers, processing circuitry and software, or some other communication devices. Communication interface 401 may be configured to communicate over metallic, wireless, or optical links. Communication interface 401 may be configured to use Internet Protocol (IP), Ethernet, Time Division Multiplex (TDM), optical networking, wireless protocols, communication signaling, or some other communication format—including combinations thereof. User interface 402 comprises components that interact with a user to receive user inputs and to present media and/or information. User interface 402 may include a speaker, microphone, buttons, lights, display screen, touch screen, touch pad, scroll wheel, communication port, or some other user input/output apparatus—including combinations thereof. User interface 402 may be omitted in some examples.

Processing circuitry 405 comprises microprocessor and other circuitry that retrieves and executes operating software 407 from memory device 406. Memory device 406 comprises a non-transitory storage medium, such as a disk drive, flash drive, data storage circuitry, or some other memory apparatus. Processing circuitry 405 is typically mounted on a circuit board that may also hold memory device 406 and portions of communication interface 401 and user interface 402. Operating software 407 comprises computer programs, firmware, or some other form of machine-readable processing instructions. Operating software 407 includes initiate module 408, identify module 409, and allocate module 410, although any number of software modules may provide the same operation. Operating software 407 may further include an operating system, utilities, drivers, network interfaces, applications, or some other type of software. When executed by processing circuitry 405, operating software 407 directs processing system 403 to operate computing system 400 as described herein.

in particular, initiate module 408 directs processing system 403 to initiate a first computing resource with a first set of user permissions (e.g., these permissions can be transmitted or otherwise provided to the first computing resource or can be referenced by the first computing resource, for example using a permission module 410 or the like). After initiating the first computing resource, identify module 409 directs processing system 403 to identify a second computing resource spawned from the first computing resource. For example, an application on the spawning first computing resource may be responsible for generating one or more supplemental virtual machines. In response to identifying the spawned second computing resource(s), permission provision module 410 directs processing system 410 to provide the spawned computing resource(s) with a second set of permissions, wherein the second set of permissions does not exceed the first set of permissions for the first computing resource. The scope of the second permission set can be established by a user, by policies in effect in an access control system, by software being executed on computing system 400 or elsewhere, and/or in other ways.

The functional block diagrams, operational scenarios and sequences, and flow diagrams provided in the Figures are representative of non-limiting exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts. It is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of providing permissions to spawned computing resources in a processing environment, the method comprising:
initiating a first computing resource in the processing environment, wherein operation of the first computing resource is limited by a first set of user-based permissions;
identifying a second computing resource in the processing environment, wherein the second computing resource is spawned from the first computing resource; and
wherein operation of the second computing resource is limited by a second set of user-based permissions, wherein the second set of user-based permissions is provided by the first computing resource and is at least as restrictive as the first set of user-based permissions.

2. The method of claim 1 wherein the first set of user-based permissions is based on a user role designation.

3. The method of claim 1 wherein the first set of user-based permissions is based on user credentials.

4. The method of claim 3 wherein the user credentials comprise a user identification and a password.

5. The method of claim 1 further comprising receiving a user request to initiate the first computing resource.

6. The method of claim 1 wherein the first set of user-based permissions and the second set of user-based permissions are implemented as one of the following:
a data block; or
a table.

7. The method of claim 1 wherein the first set of user-based permissions and the second set of user-based permissions are implemented as access to a permissions module.

8. The method of claim 7 wherein the permissions module is located outside the processing environment.

9. A method of enforcing user-based permissions on spawned computing resources in a processing environment, the method comprising:
initiating a first computing resource in the processing environment, wherein operation of the first computing resource is limited by a first user-credential-based permissions set;
the first computing resource spawning a second computing resource;
wherein spawning the second computing resource comprises providing a second user-credential-based permissions set to the second computing resource, further wherein the second user-credential-based permissions set is the same as or more restrictive than the first user-credential-based permissions set.

10. The method of claim 9 wherein the first user-credential-based permissions set comprises a plurality of permissions based on a role designation.

11. The method of claim 9 wherein the first user-credential-based permissions set is based on user credentials comprising a user identification and a password.

12. The method of claim 9 further comprising a permissions module external to the processing environment, wherein the permissions module is configured to enforce permissions within the processing environment.

13. method of claim 9 herein providing the second user-credential-based permissions set to the second computing resource comprises the second computing resource receiving data comprising a plurality of permissions included in the second user-credential-based permissions set.

14. A non-transitory computer readable storage medium having a spawned resource permission application stored thereon, the application including instructions, which when executed by one or more processors of a computing system, cause the computing system to:
initiate a first computing resource in a processing environment, wherein operation of the first computing resource is limited by a first permissions set based on user credentials, wherein the user credentials comprise a user identification and a password; and
spawn a second computing resource in the processing environment, wherein the second computing resource is spawned from the first computing resource;
wherein operation of the second computing resource is limited by a second permissions set, wherein the second permissions set is at least as restrictive as the first permissions set.

15. The non-transitory computer readable storage medium of claim 14 wherein the first permissions set comprises a plurality of user permissions based on a user role designation.

14. non-transitory computer readable storage medium of claim 14 wherein the first permissions set and the second permissions set are configured to be enforced respectively on the first computing resource and the second computing resource by a permissions module external to the processing environment.

17. The non-transitory computer readable storage medium of claim 14 wherein the second permissions set comprises data transferred from the first computing resource to the second computing resource.

18. The non-transitory computer readable storage medium of claim 14 wherein the second computing resource comprises one of the following: a processing resource, a storage resource, a network address resource.

19. The non-transitory computer readable storage medium of claim 14 wherein the first permissions set comprises permissions controlling at least one of the following:
defined access to one or more specified files;
defined access to one or more specified directories;
defined access to one or more specified servers; or defined access to one or more specified IP addresses.

20. The non-transitory computer readable storage medium of claim 16 wherein the permission module is implemented as part of a security service controlling secrets and security for the processing environment.
